(19) United States
(12) Patent Application Publication
(10) Pub. No.: US 2015/0375725 A1
(43) Pub. Date: Dec. 31, 2015

(54) Outlet Valve Arrangement of a Pump Element of a Vehicle Brake System

(71) Applicant: Robert Bosch GmbH, Stuttgart (DE)

(72) Inventor: Oliver Gaertner, Abstatt (DE)

(21) Appl. No.: 14/746,068

(22) Filed: Jun. 22, 2015

(30) Foreign Application Priority Data
Jun. 27, 2014 (DE) 10 2014 212 496.4

(51) Int. Cl. B60T 8/42; F04B 53/10; F16K 11/02

(52) U.S. Cl. CPC B60T 8/4291; F16K 11/02; F04B 53/10

(57) ABSTRACT

An outlet valve arrangement of a pump element of a vehicle brake system has an outflow duct configured to discharge a pumped fluid from an outlet valve. The outflow duct has at least three duct sections, and each of the at least three duct sections has a respective flow cross-sectional area. The flow cross-sectional area of a first duct section of the at least three duct sections is larger than the flow cross-sectional area of a second duct section of the at least three duct sections. The flow cross-sectional area of the second duct section is smaller than the flow cross-sectional area of a third duct section of the at least three duct sections.

This application claims priority under 35 U.S.C. §119 to patent application number DE 10 2014 212 496.4, filed on Jun. 27, 2014 in Germany, the disclosure of which is incorporated herein by reference in its entirety.

### BACKGROUND

The disclosure relates to an outlet valve arrangement of a pump element of a vehicle brake system, having an outflow duct which discharges a pumped fluid from an outlet valve. Furthermore, the disclosure relates to the use of an outlet valve arrangement of said type on a hydraulic assembly of a vehicle brake system.

In the case of hydraulic assemblies of vehicle brake systems, such as are used in particular for controlling an anti-lock braking system, use is made of pump elements with pump pistons which are driven by way of a motor via an eccentric drive. In particular, in this case, two pump elements are used which are arranged oppositely on the eccentric drive and which therefore deliver an associated brake fluid in alternating, intermittent fashion. The individual pump element, by way of its pump piston, realizes a sinusoidal delivery action and will correspondingly output in each case a half sine wave as pressure region per revolution of the eccentric drive. Said pressure strokes in the half sine wave are a result of the function and can be filtered only by way of damper elements connected downstream. In the associated vehicle, low-frequency pressure pulsations can however lead to pulsations of the associated brake pedal, and depending on the construction of the brake system, can under some circumstances also lead to resonant excitation of the entire vehicle. Such pressure pulsations must thus as far as possible be prevented.

### SUMMARY

According to the disclosure, an outlet valve arrangement of a pump element of a vehicle brake system is realized, having an outflow duct which discharges a pumped fluid from an outlet valve, wherein the outflow duct has at least three duct sections each with a flow cross-sectional area A1, A2 and A3 respectively, wherein A1 is larger than A2, and A2 is smaller than A3.

With the solution according to the disclosure, in an outflow duct of an outlet valve of a pump element of a vehicle brake system, specially configured flow cross-sectional areas are provided in succession, by means of which, as has been found according to the disclosure, the pressure frequency of a fluid flow passing through the outflow duct can be varied. With the variation of the pressure frequency, it is possible in particular to avoid those frequency ranges for the fluid flow and which would lead to resonant excitation in the vehicle. According to the disclosure, by means of the successive, different flow cross-sectional areas, the otherwise half-sinusoidal volume flow is interrupted immediately downstream of the point of origin, that is to say directly downstream of the pump cylinder and the outlet valve, and thus a change in the pressure frequency is effected. According to the disclosure, a particular geometry is integrated into the outflow duct, in the case of which at least initially a widening, then a narrowing and subsequently another widening are provided in targeted fashion. A volume flow Q is, as is known, defined by its flow cross-sectional area A and its flow speed c.

Q=A·c

According to the disclosure, the flow cross-sectional area A is varied in a successive manner. Where the flow cross-sectional area becomes larger, the fluid in the outflow duct flows more slowly, and where the flow cross-sectional area becomes smaller, the fluid speeds up. Altogether, according to the disclosure, the pressure pulsations are disrupted.

Said solution according to the disclosure can be produced very inexpensively and can be used for virtually all vehicle brake systems. In particular, according to the disclosure, it is possible to targetedly realize turbulence of the fluid flow in the outflow duct in order to disrupt specifically low-frequency pressure pulsations in the brake system.

In the case of the outlet valve arrangement according to the disclosure, it is preferably furthermore the case that A3 is greater than A1. Such a change in flow cross section yields, in targeted fashion between the duct sections 1 and 3, further changed flow speeds for the emerging fluid flow.

Furthermore, in the case of the outlet valve arrangement according to the disclosure, provision is preferably made, in targeted fashion, of at least two further duct sections each with a flow cross-sectional area A4 and A5 respectively, wherein A3 is larger than A4, and A4 is larger than A5. In this way, according to the disclosure, it is advantageously the case that the fluid flow is changed slightly a total of four times in succession with regard to its flow speed. In this case, it is particularly preferable, in turn, for A4 to be equal to A1. The duct section with the flow cross-sectional area A3 thus has the largest flow cross-sectional area in the flow cross-sectional area according to the disclosure. With this, it is preferably the case that the duct sections with the flow cross-sectional areas A1 to A3 are provided at least twofold in succession.

According to the disclosure, it is furthermore the case that a valve body for the outlet valve is formed around a valve axis or pump axis, said valve body being in particular of spherical form, and that the outflow duct is in the form of a radial duct leading away from the valve body. With such a refinement, the solution according to the disclosure can be realized in particularly space-saving and thus also particularly inexpensive fashion.

The outlet duct according to the disclosure is furthermore preferably formed in a valve cover or pump cover which closes off a valve housing or a pump housing. In said valve cover, the narrowings and widenings according to the disclosure in the outlet duct can advantageously be realized in cost-neutral fashion by way of the technology that is used for producing the valve cover any case. In this case, the valve cover is particularly advantageously produced by means of a cold-forming process. In the case of the outlet valve arrangement according to the disclosure, it is furthermore advantageously the case that the at least three duct sections each have a flow path length L1, L2 and L3 respectively, wherein L2 is not equal to L1, and L3 is not equal to L1. With the duct sections which are of different length in this way, the effect according to the disclosure of the change in flow speed is supplemented by a further component, specifically a component of a pressure reflection at the end of those duct sections which are subsequently narrowed. With the pressure reflection at the end of such duct sections, the pressure wave flowing through the wide duct section is reflected and directed back into the duct section. In this case, the reflections differ owing to different lengths of the duct sections, whereby an increase and also a reduction of particular pressure frequencies can be realized.

The disclosure is, in accordance with the effect attained therewith, directed specifically to use of an outlet valve arrangement according to the disclosure of said type on a hydraulic assembly of a vehicle brake system.

### BRIEF DESCRIPTION OF THE DRAWINGS

Below, the solution according to the disclosure will be discussed in more detail and by way of example on the basis of the appended schematic drawings, in which:

FIG. 1 shows a perspective view of a valve cover with an outflow duct formed therein, as per the prior art,

FIG. 2 shows a simplified longitudinal section of an exemplary embodiment of an outflow duct according to the disclosure, and

FIG. 3 shows a perspective view of a valve cover according to the disclosure with an outflow duct as per FIG. 2 formed therein.

### DETAILED DESCRIPTION

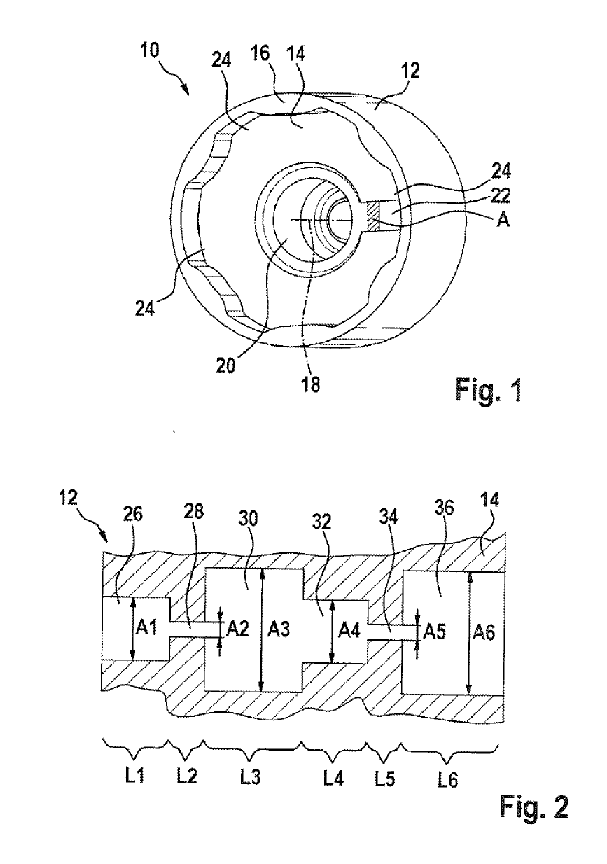

FIG. 1 illustrates an associated valve cover 12 of an outlet valve arrangement 10. The valve cover 12 serves, in the installed state, for closing off an opening of a valve housing or pump housing of a hydraulic assembly of a vehicle brake system of a passenger motor vehicle. A pump element and an outlet valve thereof are arranged in the opening. Correspondingly, the valve cover 12 may also be referred to as pump cover. The valve cover 12 has a disk-shaped, circular base section 14 and a wall section 16 adjoining said base section at the circumference. The wall section 16 thus forms a shell surface of the valve cover 12, which is of hollow cylindrical or cup-shaped form substantially along a valve axis 18. In the interior of the valve cover 12 there is situated, centrally, an outlet opening 20 for receiving a valve body (not illustrated for reasons of clarity) of an associated outlet valve. The outlet valve is a part of a pump element, in the form of a piston pump, of the hydraulic assembly, by means of which pump element brake fluid for the associated vehicle brake system can be delivered.

From the outlet opening 20, in the interior of the valve cover 12 at its base section 14, an outflow duct 22 in the form of a radial duct conducts the brake fluid delivered through the outlet valve from radially inside to radially outside. The outflow duct 22 is, according to the prior art, formed with one and the same flow cross-sectional area A over its entire flow path length L. The outflow duct 22 conducts the brake fluid into a circumferential duct 24 which extends on the inner side of the wall section 16 and which, for better distribution of the brake fluid over the circumference of the valve cover 12, is provided with an undulating internal contour there.

FIG. 2 shows the principle of an outflow duct 22 according to the disclosure in a base section 14 of an associated valve cover 12. In the case of said outflow duct 22 according to the disclosure, a first duct section 26, a second duct section 28, a third duct section 30, a fourth duct section 32, a fifth duct section 34 and finally a sixth duct section 36 are provided.

The duct sections 26 to 36 each have a flow cross-sectional area A1, A2, A3, A4, A5 and A6 respectively, wherein said flow cross-sectional areas are of different size. In particular, A1 is larger than A2. Furthermore, A3 is larger than A1 and thus also larger than A2. A4 is the same size as A1, A5 is the same size as A2, and A6 is the same size as A3. In other words, the duct sections with the flow cross-sectional areas A1 to A3 are arranged twofold in series or in succession. For the outflow duct 22 of said type, the first duct section 26 forms a first widening, the second duct section 28 forms a first narrowing, the third duct section 30 forms a second, intense widening, the force duct section 32 forms a third, less intense widening, the fifth duct section 34 forms a second narrowing, and the sixth duct section 36 forms a fourth, intense widening. As discussed above, in said duct sections 26 to 36, different flows speeds correspondingly prevail during the outflow of brake fluid, whereby pressure pulsations in the brake fluid can be influenced and in particular attenuated.

The duct sections 26 to 36 furthermore also have different flow path lengths L1 to L6, wherein L2 is smaller than L1 and L3 is larger than L1. Correspondingly, L5 is smaller than L4, and L6 is larger than L4.

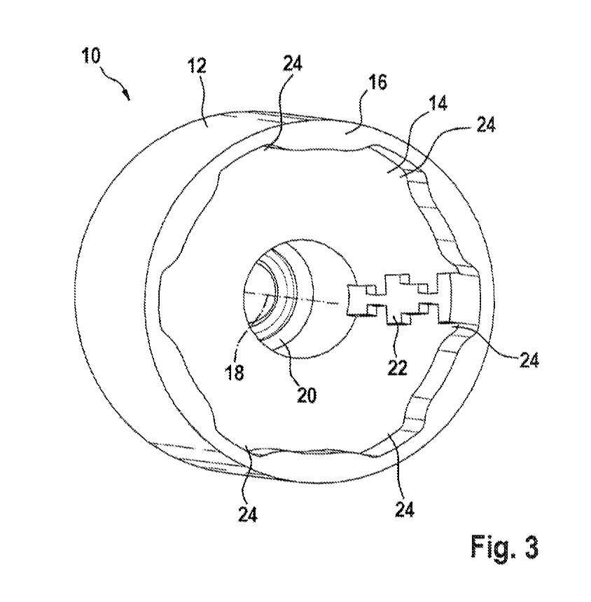

FIG. 3 shows the outflow duct 22 formed in this way with duct sections 26 to 36 in an associated base section 14 of a valve cover 12.

What is claimed is:

1. An outlet valve arrangement of a pump element of a vehicle brake system, the outlet valve arrangement comprising:
an outflow duct configured to discharge a pumped fluid from an outlet valve,
wherein the outflow duct has at least a first duct section with a first flow cross-sectional area, a second duct section with a second flow cross-sectional area, and a third duct section with a third flow cross-sectional area, and
wherein the first flow cross-sectional area is larger than the second flow cross-sectional area, and the second flow cross-sectional area is smaller than the third flow cross-sectional area.

2. The outlet valve arrangement according to claim 1, wherein the third flow cross-sectional area is larger than the first flow cross-sectional area.

3. The outlet valve arrangement according to claim 1, further comprising:
at least one fourth duct section with a fourth flow cross-sectional area; and
at least one fifth duct section with a fifth flow cross-sectional area,
wherein the third flow cross-sectional area is larger than the fourth flow cross-sectional area, and the fourth flow cross-sectional area is larger than the fifth flow cross-sectional area.

4. The outlet valve arrangement according to claim 3, wherein the fourth flow cross-sectional area is equal to the first flow cross-sectional area.

5. The outlet valve arrangement according to claim 1, wherein the first, second, and third duct sections are provided at least twofold in succession.

6. The outlet valve arrangement according to claim 1, further comprising:
a valve body for the outlet valve formed around a valve axis,
wherein the outflow duct is a radial duct leading away from the valve body.

7. The outlet valve arrangement according to claim 1, wherein the outlet duct is formed in a valve cover configured to close off a valve housing.

8. The outlet valve arrangement according to claim 8, wherein the valve cover is produced by a cold-forming process.

9. The outlet valve arrangement according to claim 1, wherein:
the first duct section has a first flow path length, the second duct section has a second flow path length, and the third duct section has a third flow path length, and
the second flow path length is not equal to the first flow path length, and the third flow path length is not equal to the first flow path length.

10. The outlet valve arrangement according to claim 1, wherein the outlet valve arrangement is configured for use on a hydraulic assembly of a vehicle brake system.
